(19) United States
(12) Patent Application Publication
(10) Pub. No.: US 2010/0235219 A1
(43) Pub. Date: Sep. 16, 2010

(54) RECONCILING FORECAST DATA WITH MEASURED DATA

(75) Inventors: Iain Merrick, London (GB); Jason Bayer, Mountain View, CA (US); John Alastair Hawkins, London (GB); Greg Hecht, Mountain View, CA (US); Michael A. Killianey, London (GB); Simon Rowe, Berkshire (GB); Geoffrey R. Smith, Mountain View, CA (US); Daniel J. Zigmond, Menlo Park, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/062,231

(22) Filed: Apr. 3, 2008

Related U.S. Application Data
(60) Provisional application No. 60/909,893, filed on Apr. 3, 2007.
(60) Provisional application No. 60/915,282, filed on May 1, 2007.

(51) Int. Cl. G06Q 30/00

(52) U.S. Cl. 705/10

(57) ABSTRACT

Systems and methods can be used to adjust an advertising budget associated with an advertising item based on forecast performance of a media item associated with the advertising item. The advertising budget can be reconciled based upon measured impressions associated with the advertising item.

### CROSS-REFERENCE

This application claims priority to: U.S. Provisional Patent Application Ser. No. 60/909,893, entitled “Television Advertising,” filed on Apr. 3, 2007; and U.S. Provisional Patent Application Ser. No. 60/915,282, entitled “Reconciling Forecast Data with Measured Data,” filed on May 1, 2007; the entire disclosures of which are both hereby incorporated by reference.

### TECHNICAL FIELD

The subject matter of this application is generally related to advertising.

### BACKGROUND

Advertising to consumers remains a strong mechanism by which a company can build and maintain its brand. While many new media technologies now contain advertisements, old media remains a strong competitor for providing an outlet for companies to use for advertisement. For example, television (e.g., cable, satellite, over the air (OTA)), radio (e.g., terrestrial radio, satellite radio, etc.), print (e.g., newspapers, magazines, etc.) and billboards remain popular mechanisms through which to spread brand awareness. However, with so many different media technologies available it can be difficult for advertisers to properly budget for a campaign.

For example, in television advertising, information pertaining to the number of viewers of the media item (e.g., television program), the genre of the media item, the time slot when the media item (e.g., television program) is presented, and the like, is vital to an advertiser in choosing an appropriate time to present an advertising item. For example, an advertiser might prefer that an advertising item related to a motorcycle dealership be presented during an episode of American Choppers (a show about custom motorcycle building) to reach the maximum target audience and, therefore, have maximum impact.

For a provider, the financial incentive to create popular content for television is to attract advertisers. For an advertiser, paying a television station to present an advertisement is an effective investment only to the extent that the advertisement reaches the advertiser's target audience. Advertisers whose products and services are limited to a relatively small geographic region tend to prefer that providers present advertisements related to their products and services at times when target audiences living in that area are viewing television. Also, viewers tend to be interested only in advertisements relevant to their requirements and interests.

### SUMMARY

This specification describes technologies related to advertising systems and methods. In some implementations, a system can include a prediction engine, a decision engine and a budget engine. The prediction engine can forecast performance data associated with a future media item. The decision engine can select an advertising item for association with the media item based on the forecast performance data from the prediction engine and based on an advertising budget associated with an advertiser. The budget engine can impound (e.g., book, reserve, etc.) a portion of the advertising budget based on the forecast performance data. The budget engine can be further configured to reconcile the advertising budget based on measured impressions associated with the advertising item.

Methods of budgeting advertising can include, for example: forecasting performance data associated with a media item based on historical data associated with a previous instance of a related media item; associating an advertising item with the media item based on the forecast performance data and based on an advertising budget associated with an advertiser; adjusting the advertising budget based on the forecast performance data; and, reconciling the advertising budget based on measured impressions associated with the advertising item.

The details of one or more embodiments of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example environment for an advertising system

FIGS. 2 and 3 are block diagrams of example advertising systems.

FIG. 4 is a block diagram of an example prediction engine 220.

FIGS. 5 and 6 are flowcharts illustrating an example process for budgeting for an advertising campaign.

FIG. 7 is a block diagram of an example advertising system including an auction engine.

FIG. 8 is a block diagram of an example television advertising environment.

### DETAILED DESCRIPTION

In an implementation, an advertising system can, for example, deliver relevant content items (e.g., advertisements) to consumers (e.g., subscribers) to facilitate provider monetization of current programming. Consumers, advertisers, providers and programmers are provided more relevant advertisements. A reporting process helps advertisers understand advertisement performance and to determine which advertisements are performing better than others to facilitate delivery of more relevant advertisements to viewers. Additionally, advertisers can, for example, more effectively test creative ideas and deliver advertising content that is more engaging to users and has greater effectiveness. By way of example, reference is made throughout the specification to advertising and delivery of advertisements. The use and delivery of other types of content (e.g., testimonials, news, reports, information, etc.) are possible.

In another implementation, the advertising system can, for example, provide accurate and timely reporting for advertisers to improve the measurability of advertising. For example, in the television environment, set-top box based measurements with anonymized data can be used to report the number of advertisement impressions delivered and facilitate timely reporting so advertisers are informed on a timely basis as to when and where the advertisements will run or have run. The reporting capability further facilitates advertisers being better able to understand what advertisements are most effective with consumers. Aggregate statistics can also be reported from millions of set-top boxes, and the aggregate statistic can complement other available data sources of information on television viewership, e.g., ratings systems.

In another implementation, the advertising system can, for example, facilitate expansion of the market by facilitating provider monetization of additional content. For example, relevant and effective advertisements for millions of television provider subscribers can be delivered locally and/or nationwide. Such relevant advertisements can more effectively monetize airtime, which can attract additional advertisers and create greater value for the television provider's television advertisement inventory. Additionally, by measuring access of programmer inventory through subscriber set-top boxes, providers can more effectively monetize specialty channels that serve smaller audiences and for which audience data have been historically difficult to measure.

In another implementation, the advertising system can, for example, broaden the reach of an advertising medium, attracting new advertisers by making advertising more easily accessible through an automated advertising process. A video advertisement marketplace, for example, can facilitate identification of producers to assist prospective advertisers in the creation of video advertisements.

In another implementation, the advertising system can, for example, create efficiencies in the buying/selling process through an automated online marketplace. For example, in one implementation, the advertising process is automated from planning the campaign, uploading the advertisement and serving the advertisement. An auction model can be used to create pricing efficiencies for both buyers and sellers of advertising. Advertisers can benefit from efficiencies by paying only for delivered impressions and receiving the information the advertisers need to continually enhance the effectiveness of the advertiser's advertisements. The system can be implemented organically or can be implemented with third-party infrastructure partners.

In one implementation, the advertising system can measure set-top box activity using channel change records, which include tuned channels and associated time stamps. Multiple ways for advertisers to target audiences with traditional approaches, such as media, network/daypart, geographic and demographic, can also be offered.

However, targeting individual set-top boxes or viewers, for example, can be precluded. In one implementation, the set-top box and account information is anonymized before being received by the advertising system. Each set-top box can include an anonymous value and includes channel change records. Account information can be anonymized and associated with location information that has no more granularity than a zip code. In this implementations, no demographic or psychographic information is associated with account information. Further, in this implementation, no information gathered from other sources is associated with account information. The anonymization can be implemented to ensure the privacy of consumers, and new functionality can be introduced with a strong focus on maintaining consumer privacy.

The reporting information of a subscriber can be received by the subscriber's provider and the reporting information can be anonymized before being provided to the advertising system. As a result, the advertising system, in some implementations, does not have direct access to non-anonymized reporting information. The aggregation of reporting information and behavior thus does not target specific households.

The reporting information can, for example, be provided by third party providers to the advertising system. The reporting information can facilitate the delivery of effective and relevant advertisements while maintaining protections on subscriber privacy. The collection of such data can, for example, be managed to ensure compliance with the laws of local and national jurisdictions.

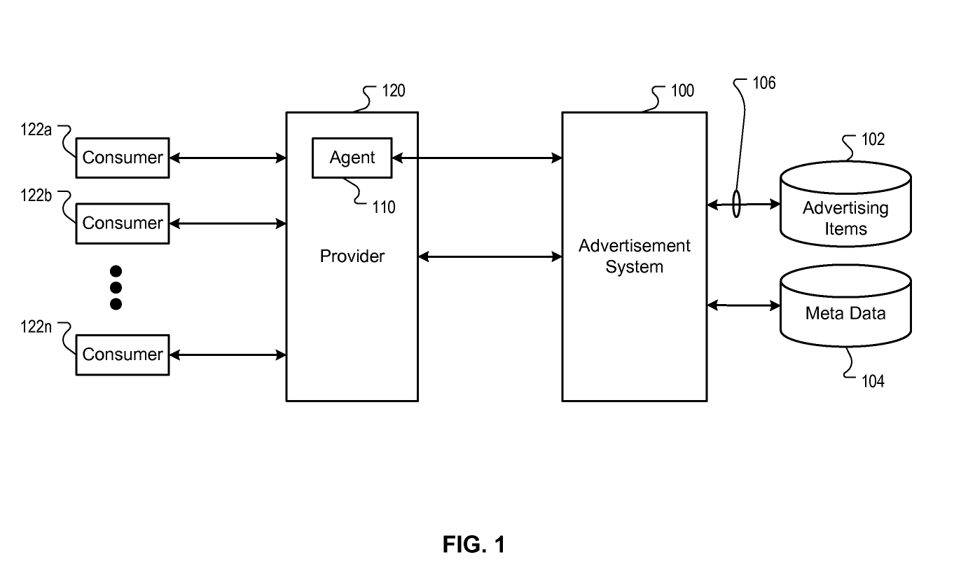

FIG. 1 is a block diagram of an example environment for an advertising system 100. In one implementation, the advertising system 100 can be implemented on one or more servers. However, in other implementations, any of the servers can be combined to perform multiple functions.

The advertising system 100 can include advertisement items (e.g., advertisements 102) and metadata 104. The advertisements 102 can, for example, include video and/or audio advertisements, banner advertisements, overlay advertisements (e.g., logos), tickers (e.g., crawlers), voiceovers, etc. The metadata 104 can include audience data, impression data, and performance data related to the advertisements 102, the advertisement metadata 104, filter data 106, etc. In an implementation, viewer information stored in the metadata 104 is anonymized.

In one implementation, the advertising system 100 can communicate with a software agent 110. The software agent 110 can, for example, be located at, or associated with, an advertising insertion location provider 120, e.g., a cable provider, a digital satellite television provider, newspaper, radio (e.g., satellite radio, terrestrial radio, etc.), cellular content provider, etc. The software agent 110 can, for example, optionally synchronize and cache advertisements, e.g., television videos, television banners, television overlays, streaming advertisements, tickers (e.g., crawlers), print advertisements, voiceovers, etc., ahead of advertisement scheduling and that are provided by the advertising system 100.

In an implementation, the software agent 110 can read schedule requests, for example, in real time or ahead of time, and identify which schedule times the advertising system 100 has permission to fill with advertisements 102. In one implementation, the software agent 110 can request the advertising system 100 server to identify a relevant advertisement 102 for an identified available advertisement slot. The advertisement 102 can be deemed relevant based on the metadata 104 and other data. For example, an advertisement for extreme sporting equipment may be selected for distribution during a sporting event for which the metadata identifies as a primary demographic 18-30 year old males.

The advertisement 102 can be scheduled based on the advertising system 100 response, and the advertisement 102 can be routed to advertisement equipment at the provider 120. The software agent 110 can read a status as to if and when the advertisement 102 was actually presented, and notify the advertising system 100 of the presentation. In another implementation, the software agent 110 can provide reporting data related to which of the consumers 122a-122n were deemed to have observed (e.g., saw, listened, read, selected, etc.) the advertisement 102. In various implementations, the reporting data can be anonymized.

In one implementation, the software agent 110 can monitor advertisement schedules that are not available for scheduling by the advertising system 100, and send the schedule data to the advertising system 100 for analysis of the advertisement market.

In an implementation, the advertising system 100 can accept requests from the software agent 110 for candidates for advertisement insertion and fetches potential candidate advertisements.

In one implementation, an advertisement filter 106 can perform one or more filtering processes to eliminate unwanted advertisements. In one implementation, the advertisement filter 106 can perform frequency capping that limits the scheduling of certain advertisements based on a certain amount of time since the advertisement was last distributed. In another implementation, an advertisement filter 106 applies competitive restrictions, where one advertisement cannot be placed near another advertisement of a competitor. Other filtering processes can also be used.

In an implementation, the advertising system 100 can identify advertisements based on account advertiser bids, budgets, and any quality metrics, e.g., conversions, viewer actions, sales numbers, etc., that have been collected.

The advertising system 100 can, for example, determine the prices for the advertisements, using one or more pricing processes. One example pricing process is a “second price pricer” where each advertiser pays the bid of the next highest advertisement multiplied by the number of impressions. Other pricing processes can also be used, e.g., bidding on reach rather than impressions, where the price paid is the bid value multiplied by the number of unique viewers over some time period.

The advertising system 100 can, for example, store in the metadata 104 relevant information related to advertisement scheduling requests and the results provided. This data may be used for internal analysis or the data can be exposed to advertisers or others.

The advertising system 100 can output the resulting advertisements as a response to a request from the software agent 110.

In one implementation, the advertising system 100 can facilitate the selection of advertisements for one particular “pod,” e.g., a grouping of advertising space (e.g., an advertising break, a section of print, etc.). In another implementation, the advertising system 100 can facilitate selection of all available advertisements throughout a programming day across multiple networks (e.g., television, newspaper, radio, internet, etc.).

In one implementation, the advertisement data 102 and/or the metadata 104 can be stored on an advertisement candidate server. In various implementations, the advertisement candidate server can be integrated into the advertisement system 100, or can be realized as a separate entity.

The advertisement candidate server can store all advertisements 102 that can be distributed, and any associated metadata (e.g., targeting data). The advertisement candidate server can handle requests from the television advertisement system 100, and can apply any targeting criteria before returning the advertisement(s) that can show for a particular request.

An example advertisement request and serving process can be as follows. The example process can be implemented in the system 100 of FIG. 1.

A request can be received for candidate television advertisements, for example, that can show in the USA/Calif./Bay Area/Mountain View, with a remoteRepositoryId of XX, for a partner provider of YY, on a television network ZZ, to be scheduled within the time window of Monday 2 PM-3 PM, most likely Monday 2:16 PM.

The candidate server can apply various targeting and filtering to the request. For example, the advertisement has been successfully synchronized to that remote repository; the advertisement targets the location or a superset of the location where the advertisement will be presented; the advertiser/owner of an advertisement has adequate budget; the advertisement is not paused, either by the advertiser or by the advertising system 100; the advertiser should not be considered fraudulent or delinquent; the partner provider, if agreed upon beforehand, has approved this advertisement for showing in these conditions; the advertisement is targeting this particular television network and/or time; the advertisement targets a television show which, through internal or third party data sources, corresponds to the given request; and/or the advertisement targets a demographic profile which, through internal or third party data sources, corresponds to the given request. Any combination of one or more such filter conditions can also be applied.

A verification process can accept distribution/status messages from the software agent 110 and update such information, e.g., update the metadata 104. This data may also be exposed to advertisers or others.

In an implementation, synchronizing of videos to the provider 120 can be facilitated, if needed. In one implementation, the software agent 110 periodically requests the advertising system 100 server for any new advertisements that need to be downloaded. For any such advertisements, the software agent 110 will initiate the download, and upon successful completion will notify the advertising system 100 of a successful download. The advertising system 100 can, for example, label the download with a particular ID that can be later user during scheduling to identify the scheduled advertisement.

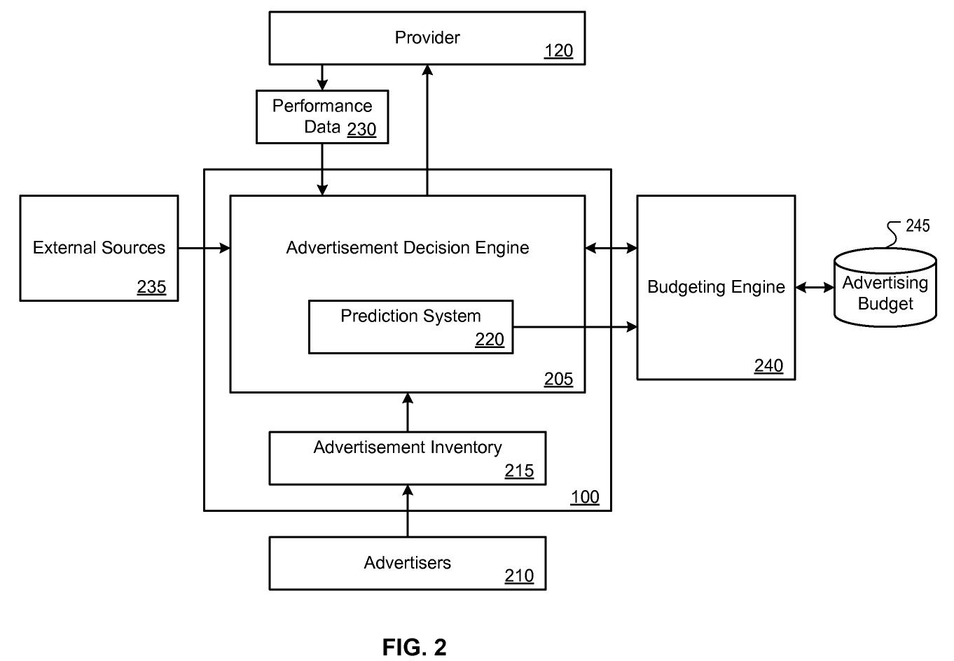

FIG. 2 is a block diagram of an example advertising system 100. The system 100 includes an advertisement decision engine (ADE) 205 and advertisement inventory 215. In some implementations, the advertisement inventory 215 can be configured to communicate with advertisers 210. The communications received can include advertising items to be presented as advertisements and information related to the advertisements (e.g., metadata). In various implementations, the metadata can include information about the advertisements, such as a target audience, locations at which the advertising item can be presented (e.g., time slots, newspaper sections, etc.), identification of particular programs that might be targeted by the advertising item, genres, or statuses of media items (e.g., first run, rerun, syndicated, etc.).

In some implementations, the input from the advertisers 210 can be used by the ADE 205 to determine how to allocate the advertising items stored in the advertisement inventory 215. Such determination can be made based on metadata associated with the advertising items, the performance of a media item, and/or an advertising budget associated with the advertising item. In further implementations, the determination can also be based upon an auction system, whereby bidding information submitted by the advertiser is used to arbitrate between two advertising items which satisfy the requirements for a slot associated with a media item. In some implementations, the advertisement inventory 215 can be stored internal to the ADE 205, and can be configured to receive input from advertisers 210.

The ADE 205 can includes a prediction engine 220. In some implementations, the prediction engine 220 can utilize information gathered by a provider 120 to predict the performance of a media item. The performance of a media item can be used as a proxy for forecasting the performance of an advertising item associated with the media item. The information gathered by a provider 120 can include measurement of historical data associated with one or more media items, respectively, such as, for example, user-activity logs, circulation, impressions, set top logs, among many others. This information gathered by the provider 120 can be communicated to the ADE 205 as performance data 230.

The performance data 230 can be periodically transmitted to the ADE 205 in some implementations. However, in other implementations, the ADE 205 can actively pull the performance data 230 from the provider 120. In further implementations, the ADE 205 can specify to the provider 120 which of a plurality of fields are being requested. The provider 120 can then gather the information for the specified fields requested by the ADE 205, and can push the information to the ADE 205. In other implementations, the ADE 205 can pull the information directly from the consumer (e.g., using a set top box, polls, etc.), or can obtain performance data using a third party statistician (e.g., Neilsen ratings available from Neilsen Media Research of New York, N.Y.).

In some implementations, the performance data 230 can include account information of the viewing household, for example, zip code, phone prefix, occupations, average income, and the like. In other implementations, personal data can be removed from the performance data 230 for consumer privacy reasons.

The ADE 205 can also receive scheduling information related to media items, for example, from an external source 235. For example, in television or radio implementations, scheduling information can include the program and timing of content shown on all channels or stations carried by the provider 120. The program and timing of content can include, for example, episodes titles of various television shows, location information, radio shows, reruns of various television shows, special events (e.g., Super Bowl, Oscars, sporting events, and the like), first run shows, reruns, etc.

In further implementations, the scheduling information can include specific requests for advertisements related to one or more media items or themes associated with media items. Such specific requests for advertisements can be referred to as slots. In some implementations, advertising items can be matched to slots based on targeting information associated with the advertisement and demographic information associated with the media items. Such targeted advertisements can be presented alongside media items (e.g., television shows, radio shows, newspaper columns, etc.) that present content related to the content of the advertising item. In some implementations, the scheduling information can be received from one or more external sources 235, e.g., Nielsen Media Research, Tribune Media Services, search engine data (e.g., such as can be obtained from a Google search engine, available from Google Inc. of Mountain View, Calif.), etc.

The performance data 230 can include historical data related to, for example, impressions associated with a media item or an advertising item that has been distributed in a given slot. For example, in television, the data can include a number of impressions associated with one or more advertising time slots on one or more channels that were gathered over a period of time. The performance data 230 can also include, for each media item carried by the provider 120, the previous performance, such as, the number of viewers of a television show, for example. The performance data 230 can further include, for example, a demographic associated with consumers to whom the media item was presented. The demographic comprises a breakdown of the performance data across multiple classifications. In some implementations, the performance data 230 demographics can enable the ADE 205 to derive behavioral patterns of viewers, for example, buying habits, hobbies, interests, and the like.

Based on the input from the provider 120, the prediction engine 220 can predict the performance of future media items based on historical data associated with related media items. Further, based on metadata (e.g., metadata 104 of FIG. 1) related to an advertisement item (e.g., advertisement 102 of FIG. 1) stored in the advertisement inventory 215, and scheduling and demographic information, the ADE 205 can identify an advertising item that can be presented proximate to a media item. In some implementations, the ADE 205 can use the predicted performance of a future media item as a proxy for determining the impressions that an advertising item would be predicted to collect if presented proximate to the media item. In some implementations, the determination of the impressions that an advertising item would be predicted to collect can be further based on historical data associated with the location of an advertising item within a media item. For example, location information can affect the impressions collected by an advertising item. A first advertising break associated with a television program, for example, might collect more impressions that an advertising break between television programs. Similarly, a banner ad at the top of a web page, for example, might collect more impressions than a banner advertisement at the bottom of a page. Moreover, a print ad on the front page of a newspaper, for example, might collect more impressions than one on the last page of the same newspaper. Other location based predictions are possible. Thus, location information associated with an advertising item can be used to predict the impressions associated with the presentation of the advertising item.

In some implementations, the ADE 205 can transmit an advertising item to the provider 120 for presentation within the media item (e.g., at a commercial break within a television show). In other implementations, the ADE 205 can present the media item (e.g., television program information), prediction and schedule (e.g., time slot, location, etc.) information to an advertiser 210. In such implementations, the advertiser 210 can optionally accept or reject the predicted media item. In some implementations, when the advertiser 210 rejects the media item, the advertising system can enable the advertiser to change the targeting criteria. The ADE 205 can subsequently predict another media item based on the changed targeting criteria. The provider 120 can gather performance data including the measured impressions related to all media items. The provider 120 can provide the performance data to the ADE 205. In some implementations, the ADE 205 can aggregate the performance data in order to provide more accurate future predictions by the prediction engine 220. In additional implementations, the ADE 205 can compare the predicted performance and measured impressions and uses any variations to improve future predictions of performance and/or impressions by the prediction engine 220.

Upon transmitting an advertising item to the provider 120 for distribution, the advertising system can operate in conjunction with the budgeting engine 240 and advertising budget 245 to book/reserve/impound a portion of an advertising budget 245 associated with the advertiser 210. The amount can be based upon the predicted performance (e.g., audience) of the media item and a contracted rate at which the advertiser agrees 210 to pay the provider 120.

However, when the measured performance and/or impression data is received from the provider 120 (or third party source) after the advertising item has been presented, the advertising budget can be reconciled. Such reconciliation can be based, for example, upon the measured performance and/or impression data associated with the media item and/or advertising item. In some implementations, the measured performance data and/or measured impression data can include forecasting the performance and/or number of impressions (e.g., opportunities to see). In various implementations, impounding a portion (e.g., including all) of the advertising budget 245 enables the advertiser to efficiently purchase advertising space in situations where the price is based upon a number of impressions obtained by the advertising item.

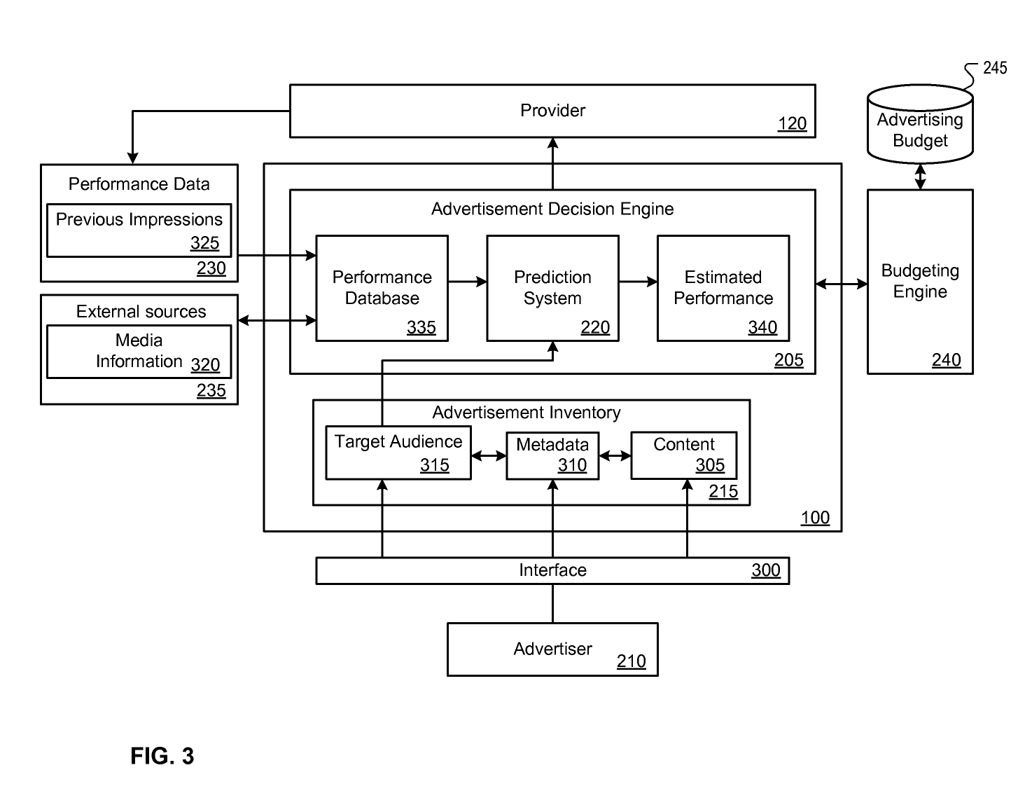

FIG. 3 is a block diagram of an example advertising system 100. The advertising system 100 can include an advertising decision engine (ADE) 205 and an advertising inventory 215. The ADE 205 can receive advertising items as input from advertisers 210, for example, using an interface 300. In some implementations, the advertising items can be stored in the advertisement inventory 215. The advertising items include the content 305 distributed to providers 120, which the providers 120 then present to the consumer. In addition, the advertising item can include related metadata 310 which indicates the nature of the content 305 in the advertising item.

By way of example, an advertising item for an automobile may include a video clip of the automobile being driven as advertising content 305. The metadata 310 associated with the advertising content 305 can include information provided by the advertiser 210 indicating that the advertising content 305 is, in general, related to automobiles, and, in specific, related to a specific make and model of a specific automobile brand. The advertising content can also include a target audience 315 specified by the advertiser 210. For example, the advertiser 210 may want the automobile advertisement to be presented to a demographic of 18-30 year olds. As such, the ADE 205 can be configured to associate the advertising item with a media item that has an audience with a high number of 18-30 year olds. In some niche markets, the ADE 205 can be configured to associate the advertising item with a media item that has an audience with a high percentage of 18-30 year olds, thereby enabling the advertiser to pay for fewer total impressions, while possibly capturing the same total number of impressions for a specific target audience.

In some implementations, the advertisement inventory 215 can be included within the ADE 205. In other implementations, the advertisement inventory 215 can be located external to the ADE 205 and can be operatively coupled to communicate with the ADE 205. In some implementations, the advertiser 210 might provide only the content 305. In such implementations, the ADE 205 can be configured to search the content 305 and determine, for example, the nature of the advertisement (e.g., automatically, or manually). Based on this determination, the advertising system 100 can be configured to determine a target audience 315. In some implementations, the advertiser can be enabled to approve or reject the target audience determined by the advertising system 100.

In those implementations where the advertising system 100 automatically determines the content of the advertising item, the advertising system 100 can compare the content 305 of the received advertising item with the content 305 of advertising items stored in the advertisement inventory 215 which have known target audiences. Where the content is similar, the advertising system 100, in some implementations, can assume that the target audiences 315 are also similar. In other implementations, the ADE 205 can compare metadata 310 associated with content 305 having an unknown target audience 315 to the metadata 310 of content 305 having a known target audience 315. The result of the comparison can be used, in some implementations, to identify a target audience 315 for the advertising item having an unknown target audience 315. For example, based on metadata 310, the ADE 205 can identify an advertising item for a car, another advertising item for a truck, and recognize that both identified advertising items are related to automobiles.

In other implementations, the advertising system 100 can receive content 305 and related metadata 310 from the advertiser 210 using an interface 300. In other implementations, the metadata 310 can directly identify a target audience based on correlation of the metadata 310 to performance data 230 (e.g., historical performance data).

The ADE 205 can be coupled to send advertising items to and receive data from a provider 120. The data from the provider 120 can be received using performance database 335. In some implementations, the performance data 230 can include impressions 325, for example, impressions 325 collected during the presentation of advertising items. In some implementations, previous impressions 325 can include the number of consumers that observed or listened to the advertising item (e.g., content 305). In some implementations, the provider 120 can obtain this information by selecting a representative group of consumers from within the provider's area of coverage and poll the representative group of consumers. In this manner, the provider 120 can obtain the impression data associated with the representative group. The provider 120 can then extrapolate the impression data of this representative group to predict the viewing habits of all consumers within the provider's area of coverage. In other implementations, performance data 230 can include, for example, the number of televisions that were active during a given media item and/or advertising item.

In such implementations, a provider 120 can obtain performance data by monitoring, for example, set top boxes and similar devices. Such devices can monitor, for example, times and durations when a viewer's television is turned on and the channels to which the set top is tuned, indicating that the consumer has had an opportunity to see an advertising item (e.g., an impression). Additionally, the devices can monitor times and durations when a consumer's recording instrument, such as digital video recorder (DVR), is active.

Such performance data 230 and impression data 325 can be transmitted back to the provider 120, and subsequently transmitted to performance database 335 for storage. Alternatively (or additionally), the performance data 230 can be transmitted directly to performance database 335 for storage.

In some implementations, the ADE 205 can be operatively coupled to receive performance data from external sources 235. The external sources 235 can include media information 320, including electronic programming guides. The electronic programming guides can provide information related to media items being shown and the times when the media items are being shown. The media information 320 can include additional information related to the media items, for example, genre, category, advisory information about the media items, and the like. Such additional information can also be collected and/or provided by sources such as Tribune Media Services. The ADE 205 can be configured to map the content to a demographic of viewers that are likely to view the content based on the media information 320. For example, the electronic program guides can provide information related to cartoon shows and a time for presenting the cartoon shows. Based on media information 320 obtained from external sources 235, the ADE 205 can identify that the genre of content is preferable for children. The ADE 205 can identify a preferred time to show cartoon shows can be late afternoon after schools have closed for the day. Accordingly, the ADE 205 may choose late afternoon to present advertisements related to toys. In other implementations, external sources 235 can include search engine data, social networking data, and other data measuring activity on the internet related media items.

In some implementations, the media information 320 collected by external sources 235 can include impression statistics collected by third parties such as Nielsen Media Research and household statistics collected from individual households, and provided to the ADE 205. The provider 120 and the external sources 235 can transfer the data and the information to the ADE 205. While the information collected and stored in performance database 335 from providers 225 may be representative of the area covered by the provider 120, information from external sources 235 such as Nielsen Media Research, for example, might provide impressions data collected from a national audience. In some implementations, the data stored in performance database 335 can be collected from both providers 225 and external sources 235.

In some implementations, information collected from representative groups of viewers can provide data related to the number of viewers of a media item or advertising item. For example, when a television is viewed by a viewer belonging to the representative group and others, the number of impressions recorded includes the viewer and the others. However, since the representative group does not cover all viewers in a provider's area of coverage, extrapolating the data collected from the representative group to all viewers in the area of coverage can be speculative. Information monitored by set top boxes and similar devices (e.g., set top logs) provides data related to the number of television that were on, the times when the televisions were on, and the channels that a set top box associated with the television were tuned to. However, this information might not accurately represent the number of viewers of each television. In some implementations, the ADE 205 can obtain data from the set-top boxes or both set-top boxes and representative groups, combine this data with similar data collected for a national audience from external sources 235, and predict the future performance of a media item and/or the impressions associated with an advertising item.

In some implementations, the data obtained from providers 225 can be used to build a model of the consumer household. For example, upon obtaining permission from consumers, providers 225 may gather supplemental information about the consumers' respective households along with their media habits. Such supplemental information can include zip code, telephone information, and the like. The supplemental information can be combined with information obtained from external sources 235 (e.g., Experian) to model the average number of family members in consumers' households, their ages, buying habits, and the like. Such information can also be used to improve targeting and predicting impressions for presenting advertising items (e.g., commercials, logos, tickers, banner ads, voiceovers, etc.). Such information can be further used, for example, to provide a model such that future performance data can be collected and modeled without the inclusion of personal information.

The information obtained from providers 225 and external sources 235 can be input to the ADE 205 and stored in the performance database 335. The media information 320 and previous impressions 325 can be regularly updated based on input from providers 225 and external sources 235. The media information 320 obtained from and external sources 235 changes regularly with addition of new content, reruns of old content, special events, and the like. The performance data 230 may receive updates at a frequency decided by the provider 120 and the external sources 235. In some implementations, the performance data 230 can overwrite the information based on updates received at one frequency and transmit the updated information to the performance database 335 at a different frequency. In other implementations, the updates can be transmitted to the ADE 205 and the performance database 335 can be updated at the same frequency with which the updates are received.

The data stored in the performance database 335 can be input to the prediction engine 220 in the ADE 205. Based on the input received from the performance database 335, the prediction engine 220 outputs forecast performance 340. The forecast performance 340 can provide a forecast of a number of impressions for an advertising item. In some implementations, the prediction engine 220 can predict the number of impressions with a high level of granularity, e.g., the impressions for each advertising item during each second.

In some implementations, the data in media information 320 and previous impressions 325 can be collected from one or more providers 225 and external sources 235 over a period of time. In predicting the number of impressions at a given time on a given channel, the prediction engine 220 can apply statistical techniques, e.g., averaging, to the previous impressions 325 collected for that time at that channel to previously collected data. In addition, the prediction engine 220 can factor in media information 320 including new content, reruns of old content, special events, demographic habits, and the like. Upon approval by consumers in the provider's area of coverage, the prediction engine 220 may also use a consumer's buying pattern based on a consumer's geographic location as a factor in the prediction engine 220. In addition, the prediction engine 220 can also use data collected by consumer interaction with, for example, an electronic program guide.

In some implementations, the prediction engine 220 can receive the target audience 315 as input from the advertisement inventory 215. The prediction engine 220 can compare data in the performance database 335 with the metadata 310 and target audience 315 related to an advertisement in the advertisement inventory 215 to predict that, if a chosen advertisement is presented in proximity to a media item, the chosen advertising item would generate a forecast performance 340. Such predictions can be used by advertisers 210 to decide whether to present their advertisements.

In other implementations, the prediction engine 220 can predict a forecast performance 340 and correlate the forecast performance 340 to a target audience 315 specified by the advertiser 210. For such predictions, the prediction engine 220 can rely on past measurements of previous impressions 325 as well as media information 320 related to the type of content, the target audience that the content is designed for and the like. In some implementations, the prediction engine 220 can include, for example, past and future schedules of programs on the television channel for which impressions are predicted, other television channels, or both. The prediction engine 220, in some implementations, can receive input that a special event is scheduled to be shown on a television channel, for example. The prediction engine 220 can associate a weight to the past impressions of consumers who viewed the television channel when incorporating the past impressions in the statistical function to calculate future impressions. The ADE 205 can use such information to choose advertisements for presentation alongside the media items which share a related or common theme. In some implementations, the prediction engine 220 can identify trends in previous impressions 325 and incorporate the trends into the statistical techniques to calculate forecast performance 340.

The advertising system 100 can also communicate with a budgeting engine 240, which control an advertising budget 245. The budgeting engine 240 can reserve/book/impound a portion of the advertising budget when an advertising item is placed for distribution. The size of the portion of the advertising budget to be impounded can be based, for example, upon the forecast performance of a media item in which the advertising item can be placed for presentation. Such impounding can provide an approximation of the total cost of the advertisement when the advertising rate is based upon an measured number of impressions. The impounding can also enable the advertiser to purchase additional advertising slots with some degree of confidence that the budget includes room for such a purchase.

In some implementations, the forecast number of impressions can be set to meet a specific confidence level (e.g., 90%) that there will be no underage in the amount impounded from the advertising budget. In such implementations, the advertiser can be confident that the amount impounded is greater than the final budget. Thus, the budget engine 240 can be implemented to provide a high-end forecast for budgeting purposes so that the likelihood that the advertiser will go over budget is low. In other implementations, the advertiser can specify a confidence level based on the advertiser's comfort level with the risk of a potential overage. In such implementations, advertisers that are comfortable with potential overages can request, e.g., a 50% confidence level, meaning that, on average, half of the forecasts will be low, and half of the forecasts will be high. Alternatively, where the advertisers are not comfortable with the risk of potential overage, the advertisers can choose a higher confidence level (e.g., 90%, 95%, 99%, etc.). In some instances, there may even be reason for an advertiser to request a low confidence level (e.g., 30%) that is likely to produce overage.

When the measured performance of a media item, or the measured impressions of an advertising item are determined, the budgeting engine 240 can reconcile the budget to account for any overage or underage in the impoundment. For example, if the forecast performance associated with the media item is lower than the measured performance associated with the media item or the measured impressions for the advertising item, additional funds can be debited from the advertising budget 245. Alternatively, if the forecast performance associated with the media item is higher than the measured performance associated with the media item, or higher than the measured impressions associated with the advertising items, budget funds can be released back into the advertising budget 245 and made available for additional advertising purchases for that advertiser. In some implementations, the advertising system 100 can enable the advertiser, for example, to overbuy advertising, recognizing that the actual cost is likely to be less than the projected cost. Such overbuying can be implemented by inflating the advertising budget by a specified amount. Alternatively, overbuying can be implemented, for example, by increasing the risk of potential overage as described above.

In some implementations, an advertiser can specify multiple advertising budgets. For example, an advertiser might produce several advertising items. Each of the advertising items may have a different target, or different efficacy. As such, the advertiser can decide that they want to spend a first amount on a first advertisement, and a second amount on a second advertisement. Thus, in such implementations, the advertiser can specify a budget for each of several advertisements. Alternatively, the advertiser can specify a budget for each of several groups of advertisements (e.g., campaigns). Other budget allocations are possible.

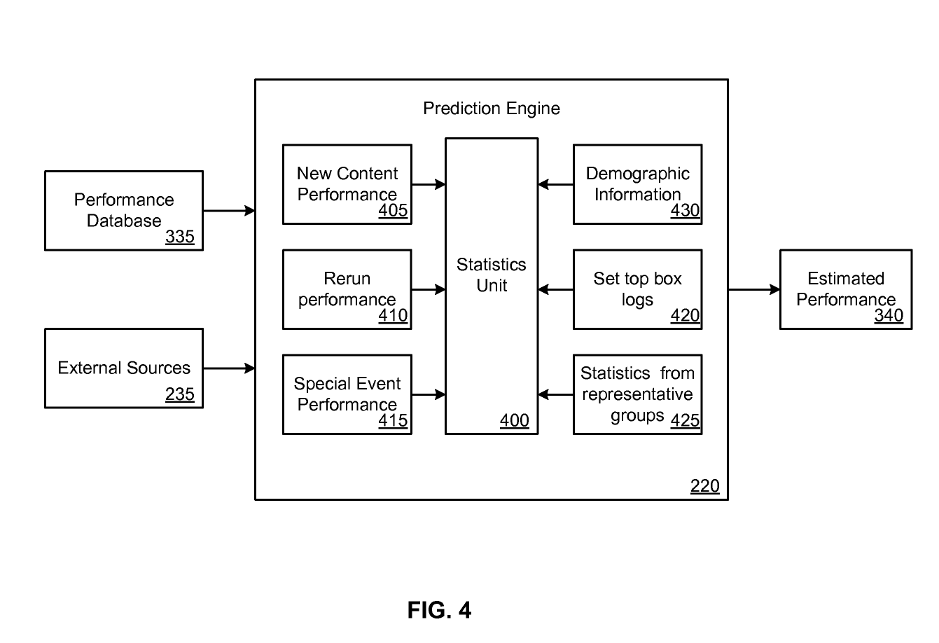

FIG. 4 is a block diagram of an example prediction engine 220. The prediction engine 220 can be used to predict a forecast performance 345 associated with a media item (e.g., a television program). The prediction engine 220 receives input from the performance database 335 and out of band data (e.g., external sources 235). Input from the performance database 335 can include performance data associated with media items (e.g., television show ratings, set top logs, circulation, polling information, etc.) which can include impressions data (e.g., “opportunity to see” an advertisement) collected during the presentation of advertising item. Input from out of band sources (e.g., external sources) can be included as internet activity metrics (e.g., internet search engine data, social networking data, search popularity, relevance, etc.), media information (e.g., electronic program guide information, reviews, user ratings, genre, actors, circulation metrics, etc.), and other data available from third parties. In some implementations, out of band data can be used to identify, for example, an “internet buzz” surrounding a new media item for which there is no historical data. For example, some recent movies (e.g., “Snakes on a Plane” and “Borat: Cultural Learnings of America for Make Benefit Glorious Nation of Kazakhstan”) have received enormous internet traffic. Such internet traffic data can be used, for example, to predict the performance of a media item.

In some implementations, the performance data and the out of band data can be collected over a period of time. The forecast performance 340 can be calculated by a statistical unit 400 using statistical techniques. In some implementations, the statistical unit 400 includes information, such as, statistical information related to the performance of new content 405, performance of reruns 410, special events 415, set top logs 420, statistics from representative groups 425, and demographic information 430. In various implementations, one or more of these classes of data can be used to derive a forecast performance associated with a media item. In other implementations, other classes of data can be used. For example, in print media, circulation statistics can be used to derive a forecast performance 340 associated with a media item.

By way of example, the prediction engine 220 can receive input related to performance for a show on NBC at 8:00pm on 3 previous Tuesdays. The prediction engine 220 can include a statistics unit 400 that can apply a statistical function (e.g., average) to the performance from previous weeks to predict the performance at 8:00 pm on NBC on an upcoming Tuesday. Additionally, the statistics unit 400 can receive input that the show on NBC at 8:00 pm on the following Tuesday night is a rerun of a show from 2 weeks before. By factoring this information during calculation, the statistics unit 400 can predict that the impressions at 8:00 pm on NBC on the following Tuesday night may be lower than on previous Tuesdays.

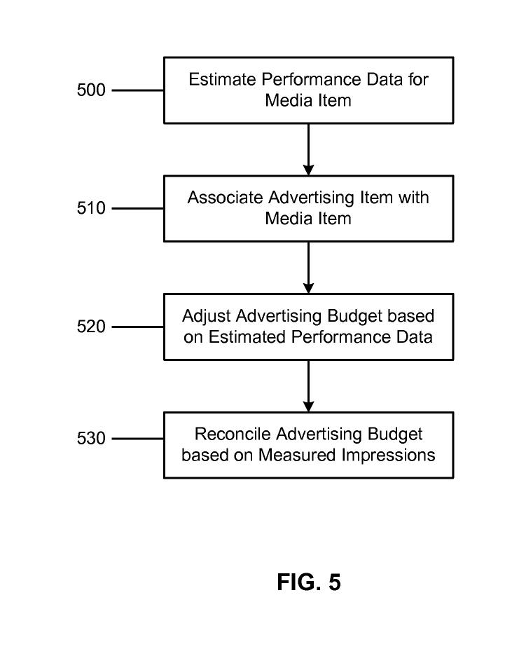

FIG. 5 depicts a flow chart of an example process for budgeting for an advertising campaign. In some implementations, the performance data associated with a media item can be forecast at stage 500. Performance data can be forecast for example, using a prediction engine (e.g., prediction engine 220 of FIG. 2). The performance data can be forecast based on one or more related media items. For example, a television program at the same time slot, with the same title, which are both reruns or both new programs, are likely to have a high degree of correlation between previous week's performances and upcoming performance. Television programs with the same title that occur during different timeslots are likely to have at least some correlation between past performance and future performance. Statistical data regarding such correlations (and other correlations) and their relationship to the past performance data can be used to forecast future performance data.

At stage 510, advertising items can be associated with the media item. In some implementations, the advertising items are associated with media items by an advertising system (e.g., advertising system 100 of FIG. 1). Advertising items can be associated with a media item through the advertising system's response to an advertisement scheduling request from a provider (e.g., provider 120 of FIG. 1). The provider can request advertising items, for example, using an agent (e.g., agent 110 of FIG. 1). In some implementations, the advertising system can identify which of a plurality of advertising items includes target audience that is correlated to the demographics associated with the media item. In further implementations, the advertising system can use an auction to determine which of a plurality of advertisements which are correlated to the media item are to be presented based upon bidding information submitted by an advertiser associated with a respective advertising item.

At stage 520, an advertising budget can be adjusted based on forecast performance data. In some implementations, the advertising budget can be adjusted by a budget engine (e.g., budget engine 240 of FIG. 2). The budget engine can adjust the advertising budget by multiplying the forecast number of consumers receiving the advertising item by a contracted rate (e.g., cost per thousand impressions) to produce a product, and subtracting this product from the advertising budget. In some implementations, an adjustment of an advertising budget impounds the portion of the budget implicated by the forecast performance and the advertising rate, such that the remaining funds can be used to purchase additional advertising spots.

At stage 530, the advertising budget is reconciled based on measured impressions. The budget reconciliation can be performed, for example, by a budget engine (e.g., budget engine 240 of FIG. 2). In some implementations, when the advertising item does not obtain as many impressions as would be expected based on the forecast performance for the media item, the reconciliation process can reclaim any excess advertising budget which was impounded in stage 520. Alternatively, when the advertising item obtains more impressions than would be expected based on the forecast performance for the media item, the reconciliation process can claim any underage from the advertising budget that was not impounded in stage 520.

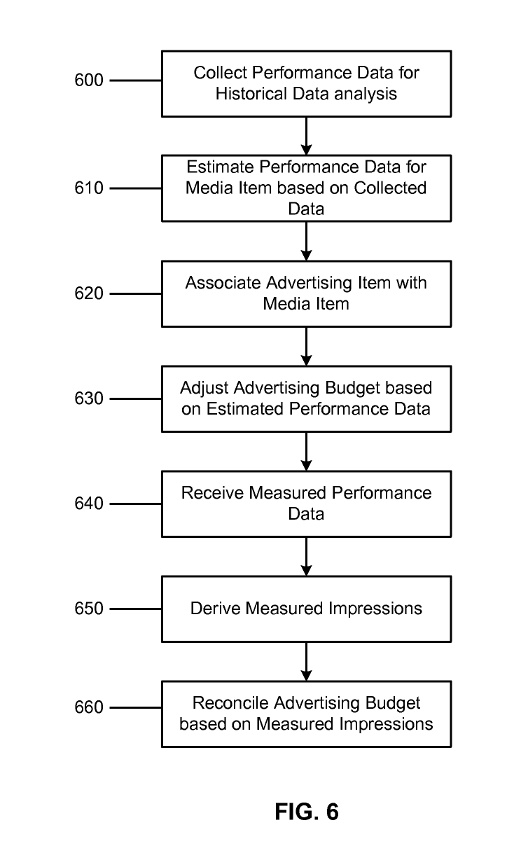

FIG. 6 depicts a flow chart of another example process for budgeting for an advertising campaign. In some implementations, performance data can be collected at stage 600. The performance data can be collected, for example, by a performance database (e.g., performance database 335 of FIG. 3). The performance data can include, for example, data regarding the performance of a media item. In some implementations, performance data can include media item information (e.g., television programming information, radio programming information, newspaper section information, timeslot, size, etc.), a number of consumers receiving the media item and/or advertising item (e.g., based on set top logs, polls, third party services, etc.), among others.

The performance data associated with a media item can be forecast at stage 610. Performance data can be forecast for example, using a prediction engine (e.g., prediction engine 220 of FIG. 2). The performance data can be forecast based on previous instances of the media item, previous performances in the timeslot, performance of other media items adjacent to the media item, third party information (e.g., polling, internet activity data, etc.), status of the media item (e.g., first run, rerun, syndication, etc.). Forecasts based on other types of data, or combinations of various types of data are possible.

At stage 620, advertising items can be associated with the media item. In some implementations, the advertising items are associated with media items by an advertising system (e.g., advertising system 100 of FIG. 1). Advertising items can be associated with a media item by the advertising system's response to an advertisement scheduling request from a provider (e.g., provider 120 of FIG. 1) which can request advertising items using an agent (e.g., agent 110 of FIG. 1).

At stage 630, an advertising budget can be adjusted based on forecast performance data. In some implementations, the advertising budget can be adjusted by a budget engine (e.g., budget engine 240 of FIG. 2). In some implementations, an adjustment of an advertising budget impounds the portion of the budget implicated by the forecast performance and the advertising rate, such that the remaining funds can be used to purchase additional advertising spots.

At stage 640, measured performance data can be received. The measured performance data can be received, for example, by an advertisement decision engine (e.g., ADE 205 of FIG. 2). In some implementations, the measured performance data can be derived from data received from a provider 120. The provider 120 in various examples can receive set top logs from set top boxes associated with a consumer. In other implementations, the performance data can include statistical information or polling information received from third parties (e.g., Neilsen Media Research).

At stage 650, a measured number of impressions can be derived. The measured number of impressions can be derived, for example, by an advertisement decision engine (e.g., advertisement decision engine 205 of FIG. 3) in conjunction with the performance database (e.g., performance database 335 of FIG. 3). In some implementations, the measured impressions can be derived or estimated for example based on the performance data associated with a media item. In such implementations, a discount algorithm could be applied to the performance data to derive measured impression data.

In further implementations, set top logs can be used to derive an estimate of the measured impression data. In such implementations, the set top logs can be both overinclusive and underinclusive based on a set top being active and a television being inactive, an extended commercial break causing consumers to lose attention, more than one consumer receiving the information from a single media item instance, among many other reasons. As such, various algorithms can be applied to the set top logs to derive an estimate of the measured number of consumers receiving the advertising item. In some implementations, the estimated measurement of impressions can be derived based on a confidence interval. For example, the estimated measurement of impressions can be set such that there is a 90% confidence that the estimated measurement of the number of impressions is below a real-life number of impressions.

At stage 660, the advertising budget is reconciled based on measured impressions. The budget reconciliation can be performed, for example, by a budget engine (e.g., budget engine 240 of FIG. 2). In some implementations, when the advertising item does not obtain as many impressions as would be expected based on the forecast performance for the media item, the reconciliation process can reclaim any excess advertising budget which was impounded in stage 630. Alternatively, when the advertising item obtains more impressions than would be expected based on the forecast performance for the media item, the reconciliation process can claim any underage from the advertising budget that was not impounded in stage 630.

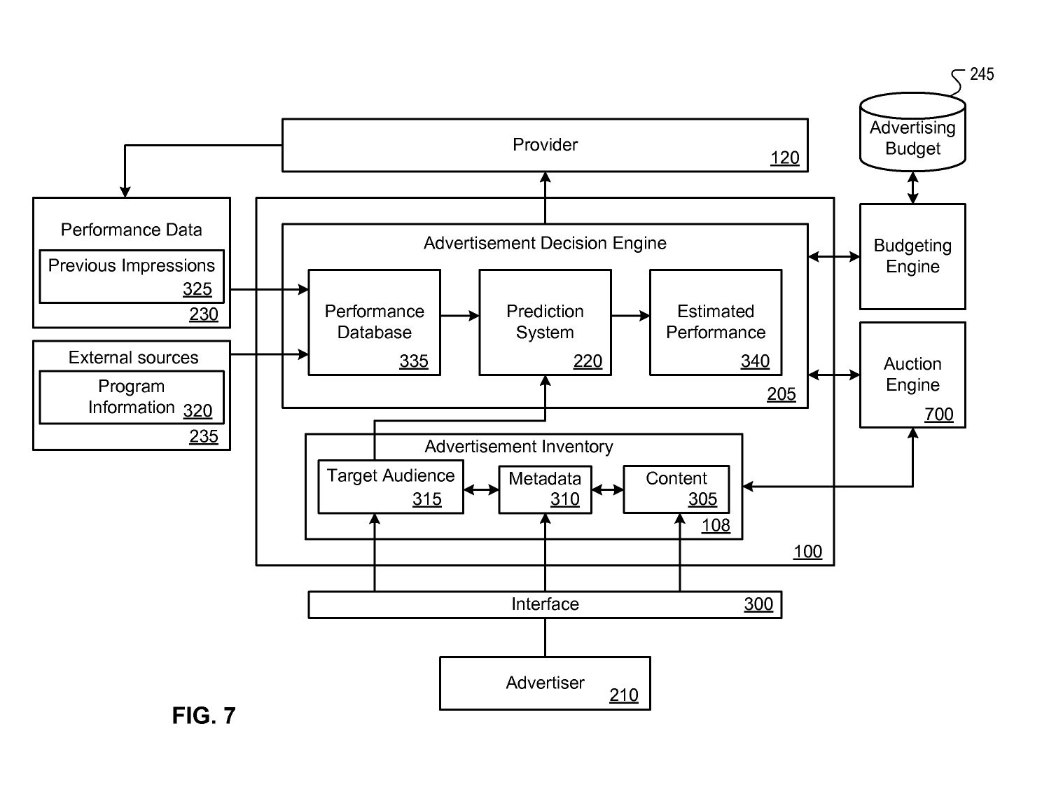

FIG. 7 is a block diagram of an example advertising system including an auction engine. The advertising system can operate substantially as described in reference to FIGS. 2 and 3. However, in FIG. 7 the ADE 205 is operable to communicate with an auction engine 700. The ADE 205 can be configured to communicate with the auction engine 700 when multiple advertising items satisfy a particular advertising slot. The auction engine 700 is operable to arbitrate between the advertising items to determine which of the advertising items will be selected to fill the advertising slot.

In one implementations, the auction engine 700 can arbitrate between advertising items based on bidding information included as part of the metadata associated with the advertising item. In some implementations, the auction could be based entirely on a rate the advertiser is willing to pay for the space. The rate could be a dollar amount per any measurable agreed to by the provider 120 and the advertiser 210. For example, a advertising item associated with “advertiser A” might include a bid at a rate of $8 per mil (e.g., $8 per thousand viewers), while “advertiser B” might include a bid at a rate of $10 per mil. In some implementations, advertiser B wins the auction.

However, in other implementations, the rate can be multiplied by a quality factor (e.g., a conversion ratio, quality score, relevance to the demographic, etc.) to determine the effective bid associated with the advertiser. In some implementations, a quality factor can include the number of consumers that are retained through the full advertisement item. For example, one advertisement item might have a poor reputation for retaining consumers through enough of the advertisement to qualify as an impression, whereas a second advertisement item might have a good reputation for retaining consumer through enough of the advertisement to qualify as an impression. Thus, providers 120 can be biased towards the second advertisement when the second advertisement is more likely to yield a higher total return notwithstanding a lower rate for the advertisement item.

For example, advertiser A might have a quality factor of 90%, while advertiser B might have a quality factor of 70%. Therefore the effective bid of advertiser A is $7.20, while the effective bid of advertiser B is $7.00. Thus, advertiser A wins the bid in the above example when quality factors are considered. Other definitions of quality factors and/or conversion ratios are possible. In various implementations, quality factors can be further based on demographic associated with the media item, or on the effectiveness of an advertising item or media item.

Moreover, though they can be difficult to measure in the radio, print and television environments, conversion ratios can be included in various implementations of this disclosure. For example, a conversion ratio can measure the effectiveness of an advertising item including a web universal resource locator (URL) by identifying a spike in internet traffic directed to the URL following the presentation of the advertising item. In other examples, the conversion ratio can measure the effectiveness of an advertisement by identifying a spike in internet traffic subsequent to the presentation of an advertisement item. Correlation between such spikes and presentation of the advertising item can be used to estimate a measurement of the impressions associated with the advertising item.

In some implementations, the auction system 700 can reset the winning bid just above the second place bid. For example, if one advertiser bid $10 per mil, and the next highest bid was $2 per mil, the winning bidder's bid can be reduced to $2.01 (or the next highest increment). Such implementations can more accurately reflect the market rate for the winning bidder. The winner party's bid can be visualized as an escalation clause, allowing the auction engine to increase each of the participant's bids until the bidder with the highest maximum bid is left.

After arbitrating among the advertising items, the auction engine 700 can communicate the determined winner to the ADE 205.

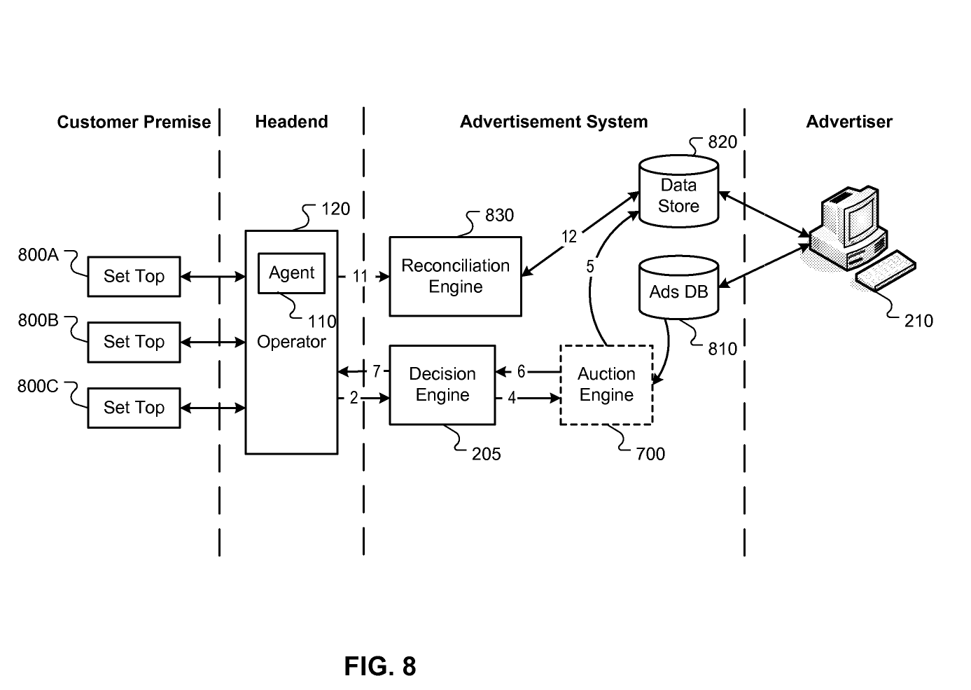

FIG. 8 is a block diagram of an example television advertising environment. In some implementations, the headend can include, for example, a provider 120. The provider 120 is operable to communicate media items to consumers (e.g., using set top boxes 800A-800C).

Prior to, or during transmission of the media items to the set top boxes 800A-800C, an agent 110 residing on the provider 120 can determine a schedule of available advertising slots. The schedule information can be transmitted to the advertisement system as a request for advertising items. The request is handled by the decision engine 205. The decision engine can communicate with an ads database 810 through an optional auction engine 700 to determine which of a plurality of ads are appropriate to fill the advertising schedule received from the agent 110. The optional auction engine 700 can arbitrate between multiple advertising items that might be appropriate to fill the advertising schedule.

Upon selection of an advertising item, information associated with the advertising item and an forecast performance of a media item into which the advertising item is to be inserted is communicated to a data store 820. The data store 820 houses the non-content oriented data associated with an advertiser, such as target audience and other metadata associated with an advertising item. The data store 820 can use the communicated information to preliminarily impound a portion of the advertiser or campaign advertising budget.

In some implementations, the selected advertising item can be communicated to the provider 120 by the decision engine 205. The agent 110 can be operable to receive the advertising item from the decision engine 205 and to insert the advertising item into a media item (e.g., television program). The provider 120 then delivers the advertising item to the set top boxes 800A-800C during the allotted time.

During the presentation of the advertising item, the provider 120 can collect measured impression data using the set top boxes 800A-800C. The set top boxes 800A-800C can create a set top log for retrieval by the provider 120. Alternatively, in some implementations, the set top log 800A-800C can be retrieved by the advertising system directly. The measured impression data collected by the provider 120 can then be communicated to a reconciliation engine 830. The reconciliation engine 830 can be operable to reconcile the predicted performance with the measured impressions associated with the presentation of the advertising item. In some examples, there can be a situation where an advertisement does not air because of overruns. In such examples, the portion of the budget that was impounded is released back into the advertising budget.

Systems and methods disclosed herein may use data signals conveyed using networks (e.g., local area network, wide area network, radio networks, television networks, internet, etc.), fiber optic medium, carrier waves, wireless networks, etc. for communication with one or more data processing devices (e.g., advertising system 100, provider 120, consumers 122a, etc.). The data signals can carry any or all of the data disclosed herein that is provided to or from a device.

The methods and systems described herein may be implemented on many different types of processing devices by program code comprising program instructions that are executable by one or more processors. The software program instructions may include source code, object code, machine code, or any other stored data that is operable to cause a processing system to perform methods described herein.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions and data structures described herein may be connected directly or indirectly to each other in order to allow the flow of data needed for their operations. It is also noted that software instructions or a module can be implemented for example as a subroutine unit of code, or as a software function unit of code, or as an object (as in an object-oriented paradigm), or as an applet, or in a computer script language, or as another type of computer code or firmware. The software components and/or functionality may be located on a single device or distributed across multiple devices depending upon the situation at hand.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

These and other implementations are within the scope of the following claims.

What is claimed is:

1. A method, comprising:
forecasting performance data associated with a media item based on historical data associated with one or more related media items;
associating an advertising item with the media item based on the forecast performance data, availability of an advertising slot associated with the media item, and based on an advertising budget associated with an advertiser;
adjusting the advertising budget based on the forecast performance data; and
reconciling the advertising budget based on measured impressions associated with the advertising item.

2. The method of claim 1, further comprising:
receiving measured performance data associated with the media item;
deriving the measured impressions based on the measured performance data associated with the media item.

3. The method of claim 1, further comprising:
receiving advertising items and metadata from an advertiser, the metadata including the advertising budget;
correlating the metadata with program information associated with the media item.

4. The method of claim 3, further comprising:
communicating an advertisement to a provider associated with the media item based on the correlation of the metadata with program information.

5. The method of claim 1, wherein the media item comprises a newspaper section.

6. The method of claim 1, wherein the media item comprises a radio program.

7. The method of claim 1, wherein the media item comprises a television program.

8. The method of claim 7, wherein the television program comprises episodic content.

9. The method of claim 8, wherein the episodic content is associated with a periodic timeslot, an aperiodic timeslot, or combinations thereof.

10. The method of claim 1, wherein the media item is associated with at least one available time slot, and associating an advertising item with the media item comprises filling the available time slot with the advertising item.

11. The method of claim 1, wherein the advertising item comprises a commercial.

12. The method of claim 1, wherein the advertising item comprises a logo overlay.

13. The method of claim 1, wherein the advertising item comprises a ticker.

14. The method of claim 1, wherein forecasting performance comprises:
forecasting future performance data associated with the media item.

15. The method of claim 1, wherein adjusting an advertising budget comprises impounding an amount equal to an expected cost for distributing the advertising item.

16. The method of claim 1, further comprising associating the advertising item with one or more additional media items based on forecast performance of said one or more additional media items, availability of an advertising slot associated with the one or more additional media items, and based on the advertising budget.

17. The method of claim 16, further comprising:
correlating the demographics associated with a media item to metadata associated with an advertising item; and
if the media item cannot be associated with each of the advertising items identified in the correlation, auctioning a spot associated with the media item based on bidding information received from advertisers associated with the advertising items.

18. A method, comprising:
forecasting television advertisement viewership for an advertisement time slot;
auctioning the advertisement time slot;
applying a probationary adjustment based on the forecast advertisement viewership to an advertisement budget associated with an auction winner;
determining measured viewership for the advertisement slot; and
reconciling the probationary adjustment with an measured adjustment based on the measured viewership

19. A system, comprising:
a prediction engine operable to forecast performance data associated with a future media item;
a decision engine operable to select an advertising item for association with the media item based on the forecast performance data, an advertising budget associated with an advertiser, and an available slot associated with the media item;
a budget engine operable to impound a portion of the advertising budget based on the forecast performance data, wherein the budget engine is operable to reconcile the advertising budget based on measured impressions associated with the advertising item.

20. The system of claim 19, wherein the budget engine is further operable to retrieve performance data associated with the media item from a provider, and to derive the measured impressions based on the performance data associated with the media item.

21. The system of claim 20, wherein the measured impressions comprise an estimate of actual impressions.

22. The system of claim 20, wherein the budget engine is operable to derive a confidence level associated with the measured impressions.

23. The system of claim 19, further comprising:
an interface operable to receive advertising items and metadata from an advertiser, the metadata including the advertising budget;
wherein the decision engine is operable to correlate the metadata with program information associated with the media item.

24. The system of claim 23, wherein the decision engine is operable to communicate an advertisement to a provider associated with the media item based on the correlation of the metadata with program information.

25. The system of claim 19, wherein the media item comprises a newspaper section.

26. The system of claim 19, wherein the media item comprises a radio program.

27. The system of claim 19, wherein the media item comprises a television program.

28. The system of claim 27, wherein the television program comprises episodic content.

29. The system of claim 28, wherein the episodic content is associated with a periodic time slot, an aperiodic time slot, or combinations thereof.

30. The system of claim 19, wherein the media item comprises a television program associated with at least one available advertising slot, wherein the decision engine is operable to select the advertising item to fill the available advertising slot.

31. The system of claim 19, wherein the advertising item comprises a commercial, a logo overlay, a voiceover, a ticker, or combinations thereof.

32. The system of claim 19, wherein the prediction engine is operable to forecast performance based upon historical data associated with one or more related media items.

33. The system of claim 19, wherein the budgeting engine is operable to impound an amount equal to an expected cost for distributing the advertisement.

34. The system of claim 19, wherein the decision engine is operable to purchase additional advertising space associated with other media items when the advertising budget enables the purchase of additional advertising space.

35. The system of claim 34, wherein the decision engine is further operable to correlate the demographics associated with a media item to metadata associated with an advertising item; and
an auction engine operable to arbitrate between a plurality of advertising items having metadata that correlate to the media item demographics, the arbitration being based on bidding information received from advertisers associated with the advertising items.

36. The system of claim 19, wherein the decision engine is further operable to select the advertising item for association with the media item based on historical data associated with one or more related advertising items.

37. The system of claim 36, wherein the relationship between the advertising item and the one or more related advertising items comprises an similar content associated with the advertising item and the one or more related advertising items.

38. The system of claim 36, wherein a relationship between the advertising item and the one or more related advertising items comprises a similar location associated with the advertising item and the one or more related advertising items.
